(19) United States
(12) Patent Application Publication
(10) Pub. No.: US 2009/0133756 A1
(43) Pub. Date: May 28, 2009

(54) METHOD OF TRANSPORTING A VISCOUS PRODUCT BY CORE ANNULAR FLOW

(76) Inventors: Yannick Peysson, Rueil-Malmaison (FR); Patrick Gateau, Maurepas (FR); Jean-Francois Argillier, Rueil-Malmaison (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/719,696

(22) PCT Filed: Nov. 9, 2005
(86) PCT No.: PCT/FR2005/002790

§ 371 Date: Feb. 6, 2009

(30) Foreign Application Priority Data
May 26, 2006 (FR) 0412285

(51) Int. Cl. F17D 1/17; F15D 1/06

(52) U.S. Cl. 137/13

(57) ABSTRACT

Method relating to the transportation of viscous products in a pipe by core annular flow, allowing to limit the restart pressures required for circulating the viscous product.

Core annular flow is a technique allowing pipe transportation of a very viscous product with limited pressure drops. However, in case of density difference between the fluids, transverse displacements of the viscous product towards the wall lead to stratification and the restart pressures are then high, because the viscous part has to be deformed. In order to limit these pressures, we propose limiting transverse displacements by injecting into said pipe a yield stress fluid allowing to generate a transverse displacement resistance. Additives can be added to the water layer conventionally used to obtain such a yield stress fluid.

Application: notably viscous hydrocarbons transportation.

### FIELD OF THE INVENTION

The present invention relates to the transportation of viscous products in a pipe by core annular flow and it concerns a method for limiting the restart pressures required for circulating the viscous product.

What is commonly referred to as Core Annular Flow (CAF) in the profession is a flow regime with pipe wall lubrication.

In particular, the method can apply during transportation of heavy oils by core annular flow in order to stop transverse oil displacements during circulation stop stages.

### BACKGROUND OF THE INVENTION

Transportation of high-viscosity oils still represents nowadays a major technological challenge. Pipe transportation of heavy or extra heavy oils, of bitumen can be mentioned by way of example. The pumping powers required for circulating the oil in the pipe can therefore be high or even prohibitive. The use of the core annular flow technique allows to obtain a significant reduction in these pumping powers. It is for example described in the following document:
Joseph D. D., Chen K. P., Y. Y. Renardy, (1997), “Core Annular Flows”, Ann. Rev. Fluid Mech., Volume 29, p. 65.

The core annular flow regime is a two-phase flow regime based on the injection, into the pipe, of a low-viscosity fluid, aqueous for example, so as to produce an annular flow. The fluid to be transported, generally more viscous, such as oil, is confined at the core of the pipe whereas the injected fluid flows as a peripheral film. The injected fluid acts as a lubricant by reducing the wall friction of the viscous fluid to be transported and it thus contributes to greatly reducing the pressure drops required for transportation.

However, in an industrial context, many factors may destabilize the annular film such as, for example, the circulation stop stages required in many spheres like crude transportation in the petroleum industry.

The method proposes acting on the nature of the fluid forming the annular film to transport a viscous product on core annular flow.

### SUMMARY OF THE INVENTION

The present invention thus relates to a method of transporting a viscous product in a pipe. This method comprises circulating said product through the agency of pumping means and injecting a fluid into said pipe in order to generate a lubricating layer between the wall thereof and said viscous product, so as to have a core annular flow circulation. The method is characterized in that the injected fluid is a fluid with a predetermined yield point value (yield stress fluid).

This yield point can be determined by evaluating a minimum yield stress from geometrical characteristics of said pipe (diameter, . . . ) and physical characteristics of said viscous product (density, . . . ).

According to the invention, the yield stress fluid can be a mixture of water and of additives in sufficient proportion to provide said mixture with shear thinning properties with a predetermined yield point.

These additives can for example be synthetic hydrosoluble polymers, natural hydrosoluble polymers, associative polymers or any association between these different polymers. More particularly, this type of additive can be selected from among the following additives: polysaccharides, xanthan gums, alginates, starches, guars, pectines, and derivatives thereof. These additives can also be clay such as montmorillonites and laponites. Finally, these additives can also be a mixture of all these different additives.

The proportion of additives can be determined as a function of the density of said viscous product. This proportion can also be determined as a function of the pumping means used for circulating said viscous product.

The invention also relates to a system for transporting a viscous product, comprising pumping means for circulating said product, means for injecting a fluid in order to create a lubricating layer between the wall of said pipe and said viscous product, so as to have a core annular flow regime during circulation. This system is characterized in that the injected fluid is a yield stress fluid.

### BRIEF DESCRIPTION OF THE FIGURES

Other features and advantages of the method according to the invention will be clear from reading the description hereafter of non limitative embodiment examples, with reference to the accompanying figures wherein:

FIGS. 1A and 1B show the distribution of the liquid phases for a CAF regime when the fluid is flowing (FIG. 1A) and stationary (FIG. 1B),

FIG. 2 illustrates the equilibrium of forces when the fluid is stationary,

FIG. 3 shows the evolution of the yield stress as a function of the density of the heavy crude for two typical pipeline diameters,

FIG. 4 illustrates the rheology of the aqueous fluid added to the xanthan polymer,

FIG. 5 shows the evolution of the apparent viscosity at 100 s⁻¹ as a function of the xanthan concentration,

FIG. 6 illustrates the rheology of the aqueous fluid added to a polysaccharide.

### DETAILED DESCRIPTION

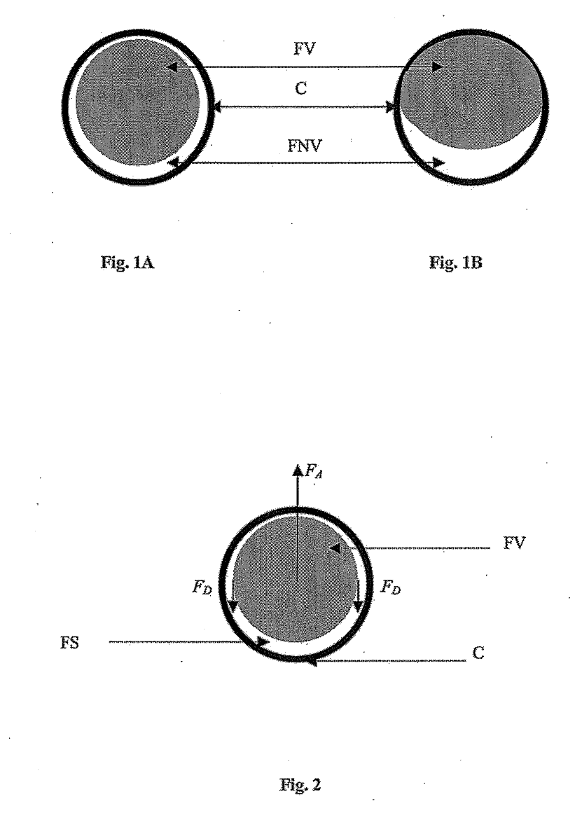

The use of the core annular flow technique allows to significantly reduce the pumping powers required for pipe transporting a viscous fluid. However, the circulation stop stages required in many industrial spheres destabilize the annular film. In fact, during these stages, the density difference between the two fluids (density of the annular film (FNV) and density of the centre (FV)) generates a transverse displacement of the viscous fluid and therefore a stratification within pipe (C), as shown in FIGS. 1A (flow) and 1B (circulation stop). The core annular flow regime gives way to a stratified flow regime. Thus, circulation stop leads to a change from a core annular flow regime to a stratified flow regime, which generates an increase in the restart pressures because the highly viscous part then requires shearing, which leads to very high wall stresses.

In order to improve the transportation of viscous products on core annular flow regime, the method proposes acting upon the nature of the fluid making up the annular film. The method comprises using a yield stress fluid in the lubricating layer. A yield stress fluid is a fluid with a particular behaviour insofar as its rheology involves a yield stress: if the stress applied to the fluid is below this yield stress, the fluid does not flow. Thus, in the context of transportation of a viscous product on core annular flow, when the fluids are circulating, the stress on the yield stress fluid is such that the fluid deforms and flows with limited wall frictions. On the other hand, during fluid circulation stops, the stress on the fluid of the wall layer is insufficient for the fluid to deform. This fluid gels, thus limiting transverse displacement of the viscous product transported towards the wall.

The method is described within the context of the petroleum industry for transportation of heavy oils on core annular flow through water injection. The method can however be readily applied to any transportation type of viscous fluids on core annular flow, including fluids comprising coarse solids of sand type and/or fine solids of clay type.

Heavy crudes are characterized by a very high viscosity, but also by a lower density close to that of water. The density difference between water and crude denoted by Δρ generally ranges between 0 and 100 kg/m³. Under such conditions, the resultant (F_{A}) of the Archimedean and gravity forces which generates a transverse upward motion of the oil cylinder (FV) remains small. The method according to the invention then proposes using a yield stress fluid (FS) to create a resistance force F_{D} allowing to counterbalance the effect of resultant (F_{A}) and therefore the motion of the crude towards the pipe wall, as shown in FIG. 2. In fact, the yield stress τ₀ characteristic of the yield stress fluid will create a resistance force F_{D} on the oil cylinder.

Yield stress τ₀ can be determined from the force equilibrium equation. In fact, force F_{D} depends on τ₀. We thus have, if the pipe is assumed to be horizontal: F_{A}=F_{D}=ƒ(τ₀). We then deduce τ₀: τ₀=ƒ⁻¹(F_{A}). Function ƒ also depending on the radius of the oil cylinder and F_{A} depending, among other things, on the density of the two fluids, it is possible to determine yield stress τ₀ from the radius of the oil cylinder and from the density of the two fluids.

One procedure consists in simply estimating F_{D} by integrating the yield stress on the surface of the oil cylinder:

F_{D}=τ₀·2π·R₀·L (1)

where:

R₀ is the radius of the oil cylinder,

L is the length of the oil cylinder,

τ₀ is the yield stress.

Similarly, resultant (F_{A}) of the Archimedean and gravity forces can be expressed as follows:

F_{A}=π·R₀²·ρₕ·g·L−π·R₀²·ρₑ·g·L=π·R₀²·Δρ·g·L (2)

where:

ρₕ is the density of the oil,

ρₑ is the density of the water.

Under such conditions, the non-motion of the oil cylinder is written considering that, per unit of length, resistance force F_{D} blocks resultant F_{A}:

π·R₀²·Δρ·g=τ₀·2π·R₀ (3)

We can thus write an equilibrium condition giving the value of the yield stress required to prevent transverse oil motion.

$${τ}_{0} = \frac{1}{2} {R}_{0} \cdot Δ ρ \cdot g \qquad ( 4 )$$

It is also possible to use the experimental measurement by Jossic and Magnin to determine the required yield stress:
L. Jossic, A. Magnin, 2001, “Drag and stability of objects in a yield stress fluid”, AIChE, 47, 12 522.

They experimentally show that equilibrium between a horizontal cylinder in a yield stress fluid leads to:

$${τ}_{0} = \frac{1}{7} {R}_{0} \cdot Δ ρ \cdot g \qquad ( 5 )$$

NB: Pre-factor ( 1/7) differs from Equation (4) because calculation of the integral of the stress on the oil cylinder was simplified for Equation (2).

The required yield stress can also be determined by means of experimental tests.

It can be noted that in the case where the transported fluid is denser than the injected fluid of the wall layer, the resultant of forces F_{A} responsible for the transverse motions will be zero.

Using a yield stress fluid thus allows to avoid, or to limit in time, a transverse motion of the cylinder of the transported fluid towards the wall, and thus stratification of the stationary fluids by counterbalancing the effect of resultant (F_{A}) of the Archimedean and gravity forces by a resistance force F_{D}. This resistance force F_{D} is a function of the yield stress of the yield stress fluid. The latter can be evaluated, for example, from the crude density and from the radius of the pipe (the wall layer being of the order of some millimeters, R₀ can be considered to be very close to the pipe radius).

The method thus comprises injecting a yield stress fluid having a sufficient yield stress to counterbalance the forces responsible for the transverse motions.

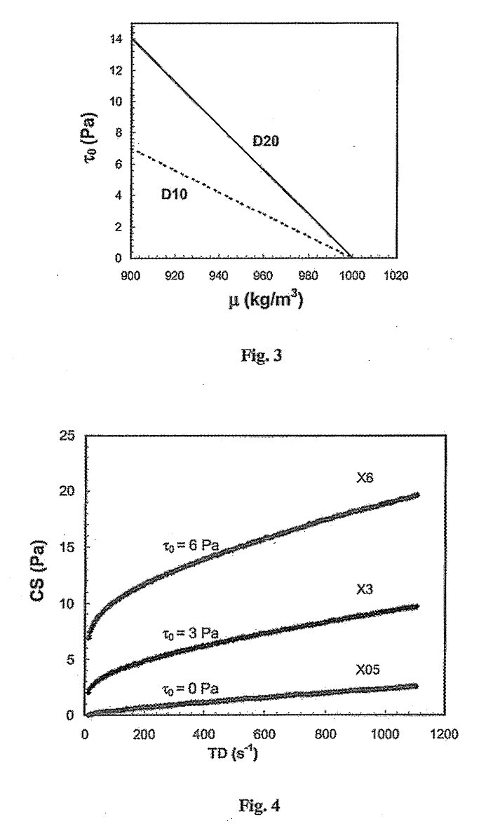

For a 10-cm radius cylindrical pipe and a heavy crude of density 950 kg/m³, it can thus be estimated that a yield stress τ₀ of 7 Pa allows stratification to be prevented when the fluid is stationary. FIG. 3 gives the required yield stress values (τ₀) as a function of the heavy crude density (μ) for two typical diameters of cylindrical heavy crude-carrying pipes: 20 cm (D20) and 10 cm (D10).

According to an embodiment, water is frequently used to create the wall layer. In this case, it is possible to create a yield stress in the water layer by injecting a proportion of additives to obtain a shear thinning yield stress fluid. It is possible to evaluate a minimum yield stress necessary to counterbalance the effect of the forces responsible for the transverse motions. The proportion of additives required to create a sufficient yield stress (at least equal to the minimum stress) in the water layer can then be determined.

A first example is given using a xanthan polymer as the additive. Various solutions were prepared depending on the proportion of polymer in the water. FIG. 4 shows three rheograms obtained from a Couette rheometer measuring the shear stress (CS) as a function of the deformation rate (TD), for various proportions of xanthan polymer: 0.5 g/l (X05), 3 g/l (X3) and 6 g/l (X6). These rheometric measurements show that the rheology of the fluid can be modelled by a Herschel-Buckley type fluid behaviour wherein the shear stress τ is described by the equation as follows:

τ=τ₀k·\dot{γ}ⁿ

where:
k is the consistency (expressed in Pa·s)
γ is the velocity gradient (deformation rate)
n is an index referred to as “gradient index”.

A yield stress τ₀ thus appears as a function of the amount of product used. It is for example possible to obtain a yield stress of 6 Pa with 6 g/l polymer in the water.

In a second example, a polysaccharide marketed by the Degussa Company (Germany) and called Actigum™ CS6 is used. This polymer was solubilized in water at different concentrations, and rheograms were acquired by means of an imposed-stress rheometer AR2000™ (TA-Instruments (UK)), equipped with a cone/plane geometry (diameter 6 cm, angle 1°). FIG. 6 illustrates these three rheograms which represent the shear stress (CS) as a function of the deformation rate (TD), for various amounts of polysaccharide Actigum™ CS6: 0.5 g/l (A05), 0.1 g/l (A01) and 0.005 g/l (A005). For a polymer concentration above 1 g/l in water, the solution exhibits a yield stress fluid behaviour that can be modelled by a Herschel-Buckley type fluid behaviour. This type of fluid has a yield stress τ₀ used in the case of the present invention to allow to limit or even to prevent any motion of the crude towards the pipe wall. Thus, with a polymer concentration of 5 g/l, the yield stress τ₀ is 3.7 Pa at 20° C. Furthermore, this type of polymer provides the solution with a marked shear thinning character characterized by a gradient index n of the order of 0.65. Thus, when the fluid is flowing, the apparent viscosity (η) greatly decreases when the deformation rate (γ) increases. Still with a polymer concentration of 5 g/l, the viscosity at 20° C. of the aqueous solution is only 54 mnPa under a deformation rate of 100 s⁻¹.

Other types of additive can be used to modify the rheology of the lubricating layer. The following additives can be mentioned in a non exhaustive way:

synthetic or natural hydrosoluble polymers: polysaccharides, xanthan gums, alginates, starches, guars, pectines, . . . , and derivatives thereof,

associative polymers, i.e. polymers consisting of a majority of hydrophilic groups and of a minority of hydrophobic groups,

dispersable clays such as, for example, montmorillonites or laponites, that can combine in water and give three-dimensional structures and yield points,

mixtures of various additives.

In the case of associative polymers, associations between hydrophobic groups in the water allow to obtain a gel in the absence of shear. This type of polymer can be obtained by chemical modification of a hydrophilic polymer, or by copolymerization between hydrophilic monomers and hydrophobic monomers. The hydrophobic functionalities can be distributed either randomly along the chain or at the chain ends, or in form of blocks.

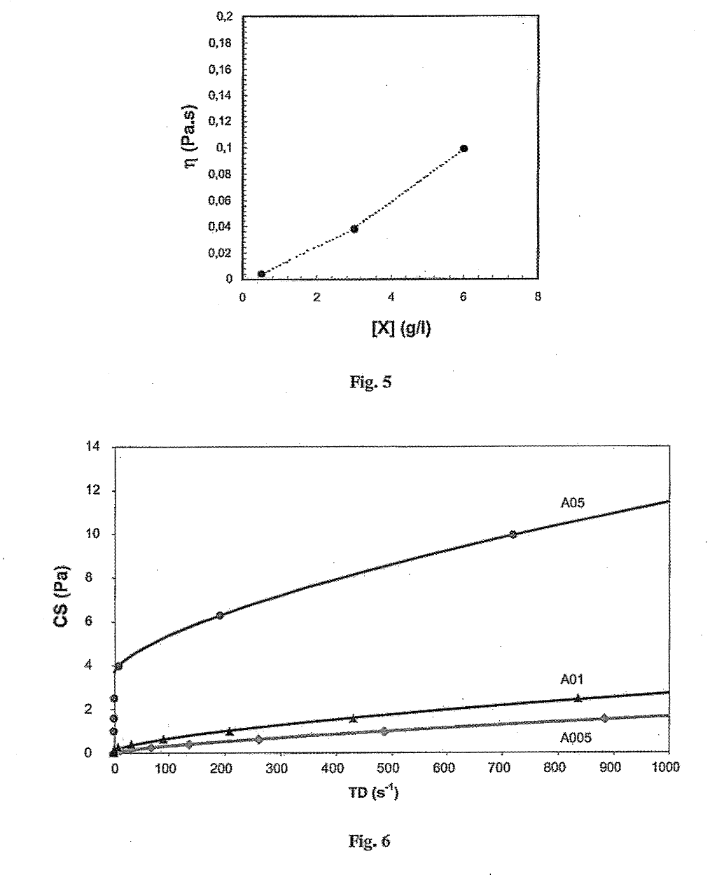

In terms of pumping pressure, one has to ensure that addition of such additives does not make the wall layer too viscous during circulation. In fact, the aim of core annular flow is to reduce the stresses of the viscous fluid on the wall and therefore the pumping pressures. One therefore has to ensure that the injected yield stress fluid, possibly obtained by mixing water and additives, has such a yield stress that, when circulation is stopped, the viscous fluid cannot flow up along the wall and that, during circulation, its viscosity is such that the stresses on the wall are markedly reduced in relation to the transported viscous fluid. The apparent viscosity (η) of the wall layer was thus measured (FIG. 5) as a function of the xanthan concentration ([X]) for a deformation rate of 100 s⁻¹. FIG. 5 shows an apparent viscosity increase linked with the presence of polymer. However, this viscosity is distinctly lower than that of a heavy crude, which allows to use such a fluid within the context of transportation by core annular flow. In the example of FIG. 5, 100 mPa·s are reached with xanthan whereas a heavy crude is 10 to 10,000 times as viscous.

In terms of restart pressure, the yield stress has to be overcome and it is therefore necessary to check that the required restart pressure is acceptable and lower than the restart pressure without the additives. The pressure drop in the pipe when circulation is restarted is given by the equation as follows:

$$\frac{Δ ρ}{L} = \frac{2 \cdot {τ}_{0}}{R} \qquad ( 6 )$$

where:

R is the pipe radius,

Δρ is the pressure drop,

L is the pipe length,

τ₀ is the yield stress.

For a yield stress (τ₀) of 7 Pa in a 10-cm radius (R) pipe, the pressure drop (Δρ) is 140 Pa/m. This value is quite acceptable insofar as values up to 300 Pa/m can be conventionally accepted in a pipe, which leads here to a maximum yield stress of 15 Pa.

The yield stress of the injected yield stress fluid thus depends on resultant (F_{A}) of the Archimedean and gravity forces. This allows to estimate an acceptable lower stress limit for limiting transverse displacements. However, as long as the viscosity is sufficiently low in relation to the viscous fluid transported, a fluid with a higher yield stress can be used. In this case, we are limited by the capacity of the pumping station.

The invention has been described within the context of transportation in a pipe in the broad sense. Applied to the petroleum industry, the method according to the invention can also be applied to surface transportation in pipelines or to hydrocarbon pumping in wells, where the pipe corresponds to the drain leading to the vertical part of the well.

According to the invention, an installation allowing the method to be implemented can comprise the following elements:

a pipe wherein the viscous fluid is circulated,

pumping means for circulating the viscous fluid in the pipe,

means for injecting the fluid into the pipe allowing to create a core annular flow regime,

means for injecting additives into the injected fluid.

1) A method of transporting a viscous product in a pipe, comprising circulating said product through the agency of pumping means and injecting a fluid into said pipe, thus creating a lubricating layer between the wall thereof and said viscous product so as to have a core annular flow circulation, characterized in that the injected fluid is a yield stress fluid of predetermined value.

2) A method as claimed in claim 1, wherein the yield point of said yield stress fluid is determined by evaluating a minimum yield stress from geometrical characteristics of said pipe and physical characteristics of said viscous product.

3) A method as claimed in claim 1, wherein the yield stress fluid is a mixture of water and additives in sufficient amount to provide said mixture with shear thinning properties with a predetermined yield stress.

4) A method as claimed in claim 3, wherein at least one of the additives is selected from among the following additives: synthetic hydrosoluble polymers, natural hydrosoluble polymers, associative polymers and any association between these various polymers.

5) A method as claimed in claim 3, wherein at least one of the additives is selected from among the following additives: polysaccharides, xanthan gums, alginates, starches, guars, pectines, and derivatives thereof.

6) A method as claimed in claim 3, wherein at least one of the additives is clay.

7) A method as claimed in claim 3, wherein at least one of the additives is selected from among the following additives: montmorillonites and laponites.

8) A method as claimed in claim 3, wherein at least one of the additives is an association between polymers and clays.

9) A method as claimed in claim 1, wherein the proportion of additives is determined as a function of the density of said viscous product.

10) A method as claimed in claim 1, wherein the proportion of additives is determined as a function of the pumping means for circulating said viscous product.

11) A system for transporting a viscous product, comprising pumping means for circulating said product, means for injecting a fluid in order to create a lubricating layer between the wall of said pipe and said viscous product, so as to have a core annular flow circulation, characterized in that the injected fluid is a yield stress fluid.
